(19) United States
(12) Patent Application Publication
(10) Pub. No.: US 2018/0205281 A1
(43) Pub. Date: Jul. 19, 2018

(54) MOTOR

(71) Applicant: NIDEC TECHNO MOTOR CORPORATION, Kyoto (JP)

(72) Inventors: Tatsuya YOSHIDA, Kyoto (JP); Satoru YAMAMOTO, Kyoto (JP); Takashi SANSHINA, Kyoto (JP); Hirotada TANAKA, Kyoto (JP)

(21) Appl. No.: 15/743,702

(22) PCT Filed: Jun. 8, 2016
(86) PCT No.: PCT/JP2016/067011

§ 371 Date: Jan. 11, 2018

(30) Foreign Application Priority Data
Jul. 29, 2015 (JP) 2015-149493
Feb. 10, 2016 (JP) 2016-023259

(51) Int. Cl. H02K 3/50; H02K 3/28; H02K 5/02; H02K 15/04; H02K 15/00; H02K 15/14

(52) U.S. Cl. CPC H02K 3/50; H02K 3/28; H02K 5/02; H02K 7/003; H02K 15/0081; H02K 15/14; H02K 15/0435

(57) ABSTRACT

In a process of manufacturing a motor, a terminal pin is first attached to an insulator of a stator. Next, an end portion of a conducting wire defining a coil is drawn out toward the terminal pin, and the conducting wire is wound around the terminal pin. Next, the conducting wire is soldered to the terminal pin. Thereafter, injection molding of a casing is performed with the stator as an insert. At this time, a mold is brought into contact with an upper surface of the insulator to surround the terminal pin with the mold. Thus, a contact of the mold with the conducting wire wound around the terminal pin is prevented. This reduces the likelihood that the conducting wire will be damaged.

### BACKGROUND OF THE INVENTION

### 1. Field of the Invention

The present invention relates to a motor.

### 2. Description of the Related Art

Molded motors of a so-called inner-rotor type and a so-called outer-rotor type, in which a rotor is arranged radially inside or outside of a stator covered with a resin, have been known. A known molded motor is described in, for example, JP-A 2000-78804. This publication describes a technique for manufacturing a resin-molded stator in which a winding terminal is wound around a terminal pin upwardly up to a predetermined position of the terminal pin, this winding terminal engaging portion is soldered, the terminal pin is press fitted for the second time, this time up to a predetermined position, and thereafter, an upper end portion of the winding terminal engaging portion is held by a molding mold, and a stator core, a stator winding, an insulator, and the winding terminal engaging portion are integrally molded and hardened with a tip portion of the terminal pin being exposed (see, for example, the abstract).

However, according to the configuration described in JP-A 2000-78804, the upper end portion of the winding terminal engaging portion is held by the molding mold when the resin-molded stator is manufactured. Accordingly, a contact with the molding mold may cause a problem such as, for example, a separation of a solder, damage to the winding terminal engaging portion, or a loosening of the winding.

### SUMMARY OF THE INVENTION

According to a first exemplary embodiment of the present invention, there is provided a motor including a stationary portion including a stator; and a rotating portion including a rotor arranged to rotate about a central axis extending in a vertical direction, and arranged radially opposite to the stationary portion. The stationary portion includes a stator core including an annular core back and a plurality of teeth arranged to project radially from the core back; an insulator arranged to cover at least a portion of the stator core, and including a base portion including a slit defined therein; coils each of which is defined by a conducting wire wound around a separate one of the teeth with the insulator therebetween; a terminal pin arranged to extend upward from the base portion of the insulator; a conductive plate arranged above the stator; and a casing made of a resin, and arranged to cover the stator core, the insulator, and the coils. The casing includes a recessed portion recessed in an axial direction. At least a portion of the terminal pin is arranged in the recessed portion. The conducting wire includes a first conducting wire portion arranged in the slit defined in the base portion; and a second conducting wire portion continuous with the first conducting wire portion, and wound around a lower portion of the terminal pin.

According to the first exemplary embodiment of the present invention, a contact of a mold with the conducting wire wound around the terminal pin can be prevented when the casing is molded. This reduces the likelihood that the conducting wire will be damaged.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical sectional view of a motor according to a first embodiment of the present invention.

FIG. 2 is a sectional view illustrating a terminal pin and its vicinity according to the first embodiment.

FIG. 3 is a perspective view illustrating terminal pins and a portion of an insulator according to the first embodiment.

FIG. 4 is a schematic diagram illustrating the shapes of the terminal pin and a conducting wire according to the first embodiment in cross sections.

FIG. 5 is a schematic diagram illustrating the shapes of a conductive plate and the terminal pin according to the first embodiment in plan views.

FIG. 6 is a flowchart illustrating a procedure performed before injection molding of a casing according to the first embodiment.

FIG. 7 is a flowchart illustrating a procedure of the injection molding of the casing according to the first embodiment.

FIG. 8 is a diagram illustrating how the injection molding according to the first embodiment is performed.

FIG. 9 is a vertical sectional view of a motor according to a second embodiment of the present invention.

FIG. 10 is a partial sectional view of the motor according to the second embodiment.

FIG. 11 is a perspective view of a stator according to the second embodiment.

FIG. 12 is a perspective view illustrating terminal pins and a portion of an insulator according to the second embodiment.

FIG. 13 is a partial sectional view illustrating the terminal pin and its vicinity according to the second embodiment.

FIG. 14 is a top view of a casing according to the second embodiment.

FIG. 15 is a partial sectional view illustrating a position sensor and its vicinity according to the second embodiment.

FIG. 16 is a partial vertical sectional view of a motor according to a modified embodiment of the present invention, illustrating an end portion of a conductive plate and its vicinity.

FIG. 17 is a top view of a conductive plate according to a modified embodiment of the present invention.

FIG. 18 is a vertical sectional view of a portion of a motor according to a modified embodiment of the present invention, illustrating a terminal pin and its vicinity.

FIG. 19 is a partial perspective view of the motor according to a modified embodiment of the present invention, illustrating a base portion, a casing, and the terminal pin.

FIG. 20 is a sectional view illustrating how injection molding of the casing is performed according to a modified embodiment of the present invention.

### DETAILED DESCRIPTION OF THE PREFERRED EMBODIMENTS

Hereinafter, exemplary embodiments of the present invention will be described with reference to the accompanying drawings. It is assumed herein that a direction parallel to a central axis of a motor is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a conductive plate is arranged with respect to a stator is an upper side, and the shape of each member or portion and relative positions of different members or portions will be described based on the above assumptions. It should be noted, however, that the above definitions of the vertical direction and the upper and lower sides are not meant to restrict in any way the orientation of a motor according to any embodiment of the present invention at the time of manufacture or when in use.

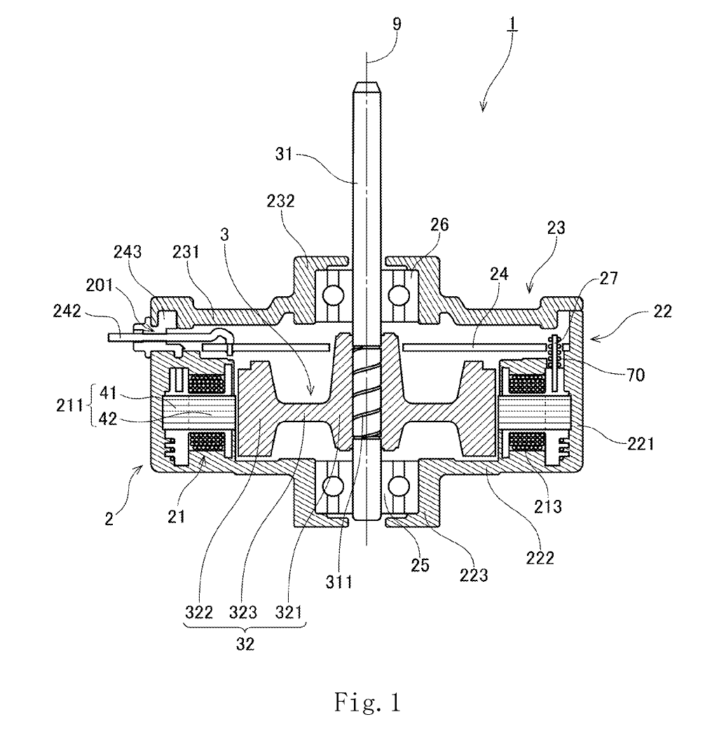

FIG. 1 is a vertical sectional view of a motor 1 according to a first embodiment of the present invention. This motor 1 is a so-called inner-rotor motor, in which a rotor 32 is arranged radially inside of a stator 21. The motor 1 is used in, for example, a household electrical appliance, such as an air conditioner. Note that motors 1 according to other embodiments of the present invention may be used in applications other than household electrical appliances. For example, motors 1 according to other embodiments of the present invention may be installed in transportation equipment, such as an automobile or a railway vehicle, an office automation appliance, a medical appliance, a machine tool, large-scale industrial equipment, and the like, and be used to generate a variety of driving forces.

Referring to FIG. 1, the motor 1 includes a stationary portion 2 and a rotating portion 3. The stationary portion 2 is fixed to a frame of an apparatus which is to be driven. The rotating portion 3 is supported to be rotatable with respect to the stationary portion 2.

The stationary portion 2 according to the present embodiment includes the stator 21, a casing 22, a cover 23, a conductive plate 24, a lower bearing portion 25, an upper bearing portion 26, and terminal pins 27. The rotating portion 3 includes a shaft 31 and the rotor 32.

The stator 21 is an armature arranged to generate magnetic flux in accordance with electric drive currents supplied from an external power supply through the conductive plate 24. The stator 21 is arranged to annularly surround a central axis 9 extending in the vertical direction. The stator 21 includes a stator core 211, an insulator 212, and a plurality of coils 213. The stator core 211 includes a core back 41 in the shape of a circular ring, and a plurality of teeth 42 arranged to project radially inward from the core back 41. The core back 41 is arranged to be substantially coaxial with the central axis 9. The teeth 42 are arranged at regular intervals in a circumferential direction. The stator core 211 is defined by, for example, laminated steel sheets.

The insulator 212 is attached to the stator core 211. An insulating resin is used as a material of the insulator 212. The insulator 212 is arranged to cover at least both axial end surfaces and both circumferential sides of each of the teeth 42. Each coil 213 is defined by a conducting wire 70 wound around a corresponding one of the teeth 42 with the insulator 212 intervening therebetween. That is, the insulator 212 is arranged to intervene between the teeth 42 and the coils 213.

The casing 22 is a member made of a resin, and arranged to hold the stator 21 and the lower bearing portion 25. The casing 22 includes a wall portion 221, a bottom plate portion 222, and a lower bearing holding portion 223. The wall portion 221 is arranged to extend in the axial direction to substantially assume a cylindrical shape. The stator 21 is covered with the resin of the wall portion 221. However, portions of the stator 21, the portions including a radially inner end surface of each of the teeth 42, are exposed from the wall portion 221. In addition, the rotor 32, which will be described below, is arranged radially inside of the wall portion 221.

The bottom plate portion 222 is arranged to extend radially inward from a lower end of the wall portion 221 to assume the shape of a plate. The bottom plate portion 222 is arranged axially below the stator 21 and the rotor 32. The lower bearing holding portion 223 is arranged to extend from an inner end of the bottom plate portion 222 to cover a portion of the lower bearing portion 25. The lower bearing portion 25 and a lower end portion of the shaft 31 are arranged radially inside of the lower bearing holding portion 223.

The cover 23 is arranged to cover an upper opening of the casing 22. The conductive plate 24 and the rotor 32, which will be described below, are housed in a housing defined by the casing 22 and the cover 23. The cover 23 includes an upper plate portion 231 and an upper bearing holding portion 232. The upper plate portion 231 is arranged to extend substantially perpendicularly to the central axis 9 axially above the stator 21, the casing 22, the conductive plate 24, and the rotor 32. The upper bearing holding portion 232 is arranged to extend from an inner end of the upper plate portion 231 to cover a portion of the upper bearing portion 26. The upper bearing portion 26 and a portion of the shaft 31 are arranged radially inside of the upper bearing holding portion 232.

A connection hole 201, through which a lead wire 242 is arranged to pass, is defined at a circumferential position between the casing 22 and the cover 23. A bushing 243 is arranged in the connection hole 201. The bushing 243 is arranged to be in contact with end surfaces of the casing 22 and the cover 23 which together define the connection hole 201, and includes a wiring groove in which the lead wire 242 is arranged.

The conductive plate 24 is a circuit board arranged to be substantially perpendicular to the central axis 9. The conductive plate 24 is arranged above the stator 21 and the rotor 32, below the cover 23, and radially inside of the wall portion 221 of the casing 22. The lead wire 242, which extends from the conductive plate 24, is arranged to pass through the wiring groove of the bushing 243 in the connection hole 201, and is drawn out of the casing 22. Then, an end portion of the lead wire 242 is connected to the external power supply. Electric currents supplied from the external power supply are passed to the coils 213 through the lead wire 242, the conductive plate 24, and the terminal pins 27, which will be described below.

The lower bearing portion 25 is arranged to rotatably support the shaft 31 below the rotor 32. The upper bearing portion 26 is arranged to rotatably support the shaft 31 above the rotor 32. A ball bearing, which causes an outer race and an inner race to rotate relative to each other through balls, is used as each of the lower and upper bearing portions 25 and 26 according to the present embodiment. The outer race of the lower bearing portion 25 is fixed to the lower bearing holding portion 223 of the casing 22. The outer race of the upper bearing portion 26 is fixed to the upper bearing holding portion 232 of the cover 23. In addition, the inner race of each of the lower and upper bearing portions 25 and 26 is fixed to the shaft 31. Note, however, that another type of bearing, such as, for example, a plain bearing or a fluid bearing, may be used instead of the ball bearing.

The shaft 31 is a columnar member arranged to extend in the axial direction through the rotor 32. The shaft 31 is arranged to rotate about the central axis 9. An upper end portion of the shaft 31 is arranged to project upward above the casing 22 and the cover 23. A fan for use in an air conditioner, for example, is attached to the upper end portion of the shaft 31. Note that the upper end portion of the shaft 31 may alternatively be connected to a driving portion other than a fan through a power transmission mechanism, such as, for example, a gear.

The rotor 32 is an annular member fixed to the shaft 31, and arranged to rotate together with the shaft 31. The rotor 32 is arranged radially inside of the stator 21. The rotor 32 according to the present embodiment is an annular member made of a plastic resin containing a magnet. Referring to FIG. 1, the rotor 32 includes an inner tubular portion 321, an outer tubular portion 322, and a joining portion 323.

The inner tubular portion 321 is a substantially cylindrical portion fixed to the shaft 31. An outer circumferential surface of the shaft 31 includes a surface to which the inner tubular portion 321 is fixed, and this surface of the outer circumferential surface of the shaft 31 includes a spiral groove 311. The rotor 32 is defined by an injection molding process with the shaft 31 as an insert. In the injection molding process, the resin in a fluid state flows into the groove 311, which is defined in the outer circumferential surface of the shaft 31. As a result, the rotor 32 is securely fixed to the shaft 31. In addition, the likelihood that the rotor 32 will rotate relative to the shaft 31 while the motor 1 is running is reduced.

The outer tubular portion 322 is a substantially cylindrical portion arranged radially outward of the inner tubular portion 321. An outer circumferential surface of the outer tubular portion 322 is arranged opposite to the radially inner end surface of each of the teeth 42 with a slight gap therebetween. The joining portion 323 is a disk-shaped portion arranged to join the inner and outer tubular portions 321 and 322 to each other. Each of the inner and outer tubular portions 321 and 322 is arranged to have the greatest radial thickness at or near a boundary with the joining portion 323. In addition, the radial thickness of each of the inner and outer tubular portions 321 and 322 is arranged to gradually decrease with decreasing distance from each axial end thereof.

While the motor 1 is running, the electric drive currents are supplied from the external power supply to the coils 213 through the lead wire 242, the conductive plate 24, and the terminal pins 27, which will be described below. As a result, magnetic flux is generated around each of the teeth 42 of the stator core 211. Then, action of magnetic flux between the teeth 42 and the rotor 32 produces a circumferential torque. As a result, the rotating portion 3 is caused to rotate about the central axis 9.

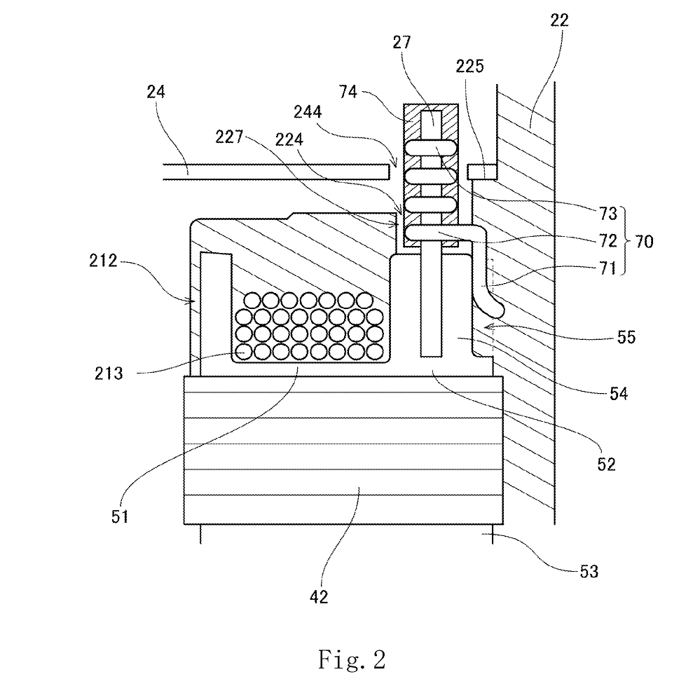

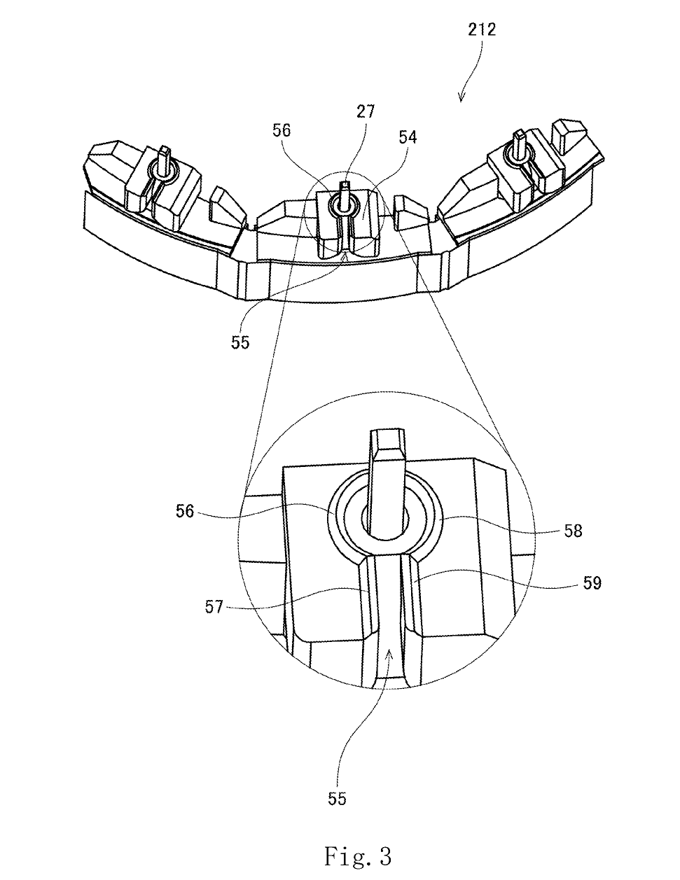

Next, the structure of a vicinity of the terminal pin 27 of the motor 1 will now be described in more detail below. FIG. 2 is a partial sectional view of the motor 1, illustrating the terminal pin 27 and its vicinity. FIG. 3 is a perspective view illustrating the terminal pins 27 and a portion of the insulator 212. In FIG. 3, the conducting wires 70 and a solder 74 are not shown.

The insulator 212 includes a first insulating portion 51, a second insulating portion 52, a third insulating portion 53, and a base portion 54. The insulator 212 may be defined by either a single monolithic member or a plurality of separate members. For example, one or more of the first insulating portion 51, the second insulating portion 52, the third insulating portion 53, and the base portion 54 may be defined separately from the rest of the first insulating portion 51, the second insulating portion 52, the third insulating portion 53, and the base portion 54.

The first insulating portion 51 is arranged to cover both the axial end surfaces and both the circumferential sides of a corresponding one of the teeth 42. The second insulating portion 52 is arranged to cover at least a portion of an upper surface of the core back 41. The third insulating portion 53 is arranged to cover at least a portion of a lower surface of the core back 41. The first insulating portion 51 is arranged to be radially continuous with each of the second and third insulating portions 52 and 53. The base portion 54 is arranged to project axially upward from the second insulating portion 52. A slit 55 recessed radially inward is defined in a radially outer side surface of the base portion 54. The slit 55 is arranged to extend from an upper end of the base portion 54 downward in the axial direction.

The terminal pin 27 is arranged on the base portion 54. The terminal pin 27 is a columnar conductor arranged to extend in the axial direction. The terminal pin 27 is made of a material having electrical conductivity, such as, for example, iron or copper. A lower end portion of the terminal pin 27 is inserted into a hole defined in the base portion 54, and is fixed to the base portion 54. An upper end portion of the terminal pin 27 is arranged above an upper surface of the base portion 54. In the present embodiment, only one of the terminal pins 27 is fixed to one of the base portions 54. Note, however, that two or more of the terminal pins 27 may alternatively be fixed to one of the base portions 54.

At least portions of surfaces of the stator core 211, the insulator 212, and the coils 213 are covered with the casing 22. The casing 22 includes a recessed portion 224 recessed in the axial direction above the base portion 54 of the insulator 212. The upper surface of the base portion 54 is arranged in the recessed portion 224. Accordingly, the upper surface of the base portion 54 is exposed from the casing 22. In addition, at least a lower end portion of the terminal pin 27 is arranged in the recessed portion 224 without contact with the casing 22.

The casing 22 is obtained by an injection molding process, i.e., pouring the resin into a cavity in a mold with the stator 21 and the terminal pins 27 housed therein and hardening the resin. The details of the injection molding process will be described below. In addition, referring to FIG. 2, the casing 22 according to the present embodiment includes a conductive plate mounting surface 225 arranged to be in contact with a lower surface of the conductive plate 24. The conductive plate mounting surface 225 is arranged at a level higher than that of an upper end portion of an outer circumferential portion of the rotor 32. A downward displacement of the conductive plate 24 is prevented by the conductive plate mounting surface 225. A contact between the conductive plate 24 and the rotor 32 is thus prevented.

A portion of the conducting wire 70 extends from the coil 213 arranged radially inside of the base portion 54, and is drawn out toward the slit 55. The conducting wire 70 includes a first conducting wire portion 71 and a second conducting wire portion 72. The first conducting wire portion 71 is arranged in the slit 55. The second conducting wire portion 72 is continuous with the first conducting wire portion 71, and is wound around a lower portion of the terminal pin 27. The second conducting wire portion 72 is arranged in the recessed portion 224. In the present embodiment, the conducting wire 70 further includes a third conducting wire portion 73 continuous with the second conducting wire portion 72 and wound around an upper portion of the terminal pin 27. The third conducting wire portion 73 is arranged above the recessed portion 224. In the above-described manner, the portion of the conducting wire 70 extending from the coil 213 may be arranged to pass through the slit 55 and be wound around the terminal pin 27 from the lower portion to the upper portion of the terminal pin 27 up to a position above the recessed portion 224. This allows adjacent turns of the conducting wire 70 wound around the terminal pin 27 to have a wide space therebetween, which leads to an improved electrical reliability.

Notice that, in the injection molding of the casing 22 of the motor 1 according to the present embodiment, which will be described below, the conducting wire 70 and the mold are kept out of contact with each other without a separate protective member being arranged to cover a portion of the conducting wire 70 which lies between the base portion 54 and the mold. Accordingly, the conducting wire 70 can be wound around the terminal pin 27 up to a position near the upper end portion of the terminal pin 27 without obstruction by such a protective member.

In addition, as illustrated in FIG. 2, the conducting wire 70 is wound around the terminal pin 27 with a gap between adjacent turns of the conducting wire 70. Further, the solder 74 is arranged in the gap between the adjacent turns of the conducting wire 70 wound around the terminal pin 27. This leads to a more excellent continuity between the conducting wire 70 and the terminal pin 27. As a result, the electric drive currents supplied from the external power supply can be passed to the stator 21 with stability, which leads to an improved electrical reliability of the motor 1.

In the present embodiment, in the recessed portion 224, a space 227 is arranged to intervene between the casing 22 and a combination of the second conducting wire portion 72 and the solder 74. That is, in the injection molding of the casing 22, the mold is not in contact with any of the terminal pin 27, the conducting wire 70, and the solder 74. This prevents each of the terminal pin 27, the conducting wire 70, and the solder 74 from being damaged in the injection molding of the casing 22.

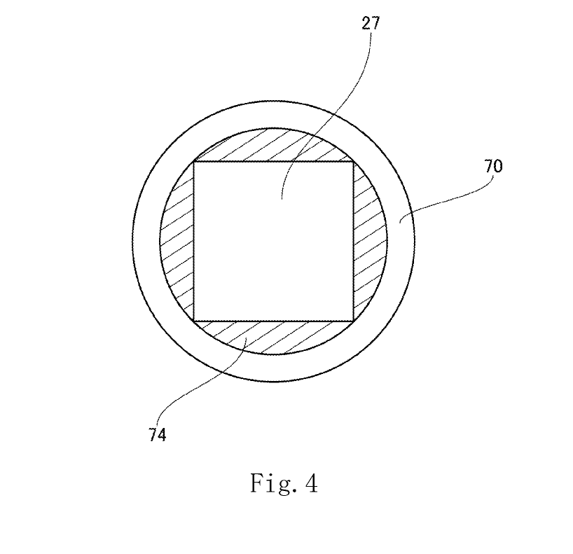

FIG. 4 is a schematic diagram illustrating the shapes of the terminal pin 27 and the conducting wire 70 in cross sections. In the present embodiment, as illustrated in FIG. 4, the shape of the terminal pin 27 in a section perpendicular to the central axis 9 is rectangular. Accordingly, gaps tend to easily occur between the terminal pin 27 and the conducting wire 70. Therefore, the solder 74 tends to easily enter into the gaps between the terminal pin 27 and the conducting wire 70. Thus, a more excellent continuity between the terminal pin 27 and the conducting wire 70 can be achieved. A metal, such as an aluminum alloy or copper, for example, is used as a material of the conducting wire 70. In particular, using an aluminum alloy rather than copper will achieve a reduction in the weight of the motor 1.

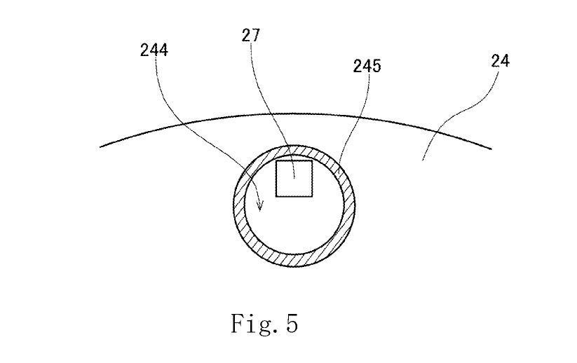

FIG. 5 is a schematic diagram illustrating the shapes of the conductive plate 24 and the terminal pin 27 in plan views. Referring to FIGS. 2 and 5, the conductive plate 24 according to the present embodiment includes a through hole 244 arranged above the recessed portion 224. A land (a first land) 245, where a copper foil is exposed, is arranged at a wall portion of the conductive plate 24 which defines the through hole 244. The terminal pin 27 is arranged to extend in the axial direction through the through hole 244. In addition, the conducting wire 70 is wound up to a position above the through hole 244. That is, an upper end of the third conducting wire portion 73 is arranged above the through hole 244. The terminal pin 27 is arranged to be in direct contact with the land 245 or in indirect contact with the land 245 with the solder 74 therebetween. Thus, a continuity between the terminal pin 27 and the land 245 of the conductive plate 24 is achieved.

Next, the injection molding of the casing 22 will now be described below.

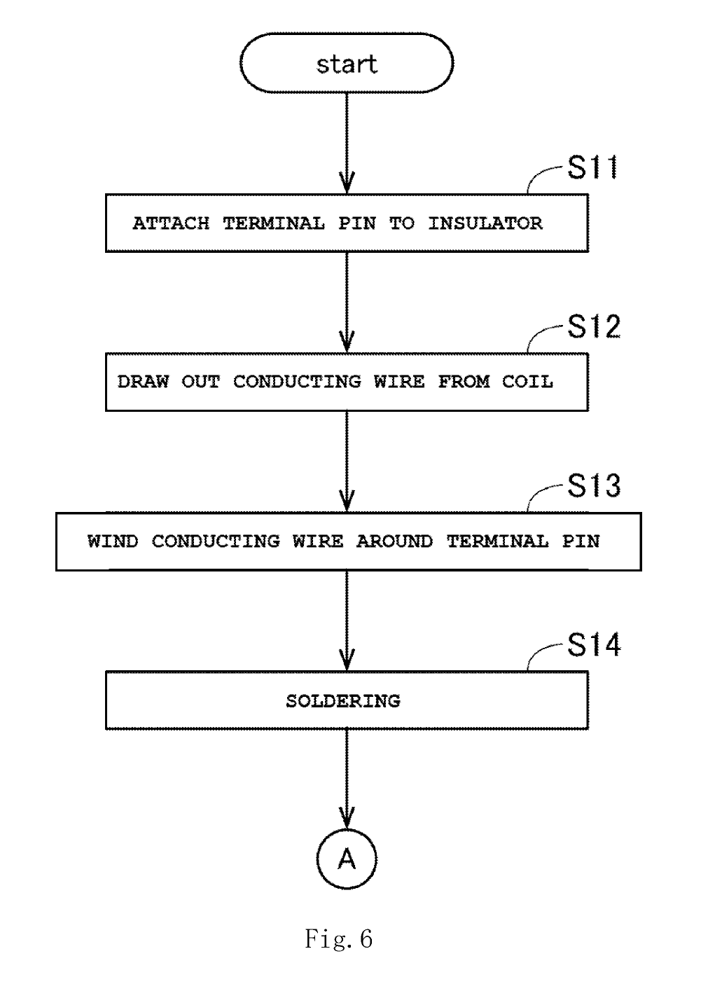

FIG. 6 is a flowchart illustrating a procedure performed before the injection molding of the casing 22. Before the injection molding of the casing 22, the terminal pin 27 is first attached to the upper surface of the base portion 54 of the insulator 212 (step S11). The base portion 54 and the terminal pin 27 may be fixed to each other through, for example, press fitting or adhesion. Alternatively, the base portion 54 and the terminal pin 27 may be fixed to each other by molding the base portion 54 with the terminal pin 27 as an insert.

Next, the conducting wire 70 defining the coil 213 is passed through the slit 55, and an end portion of the conducting wire 70 is drawn out toward the terminal pin 27 (step S12). The first conducting wire portion 71 of the conducting wire 70 is arranged along the slit 55 of the insulator 212. That is, a portion of a path of the conducting wire 70 leading from the coil 213 to the terminal pin 27 is positioned by the slit 55. Thus, a contact of the conducting wire 70 with another member can be prevented. As a result, the conducting wire 70 is prevented from being damaged or ruptured.

Then, the conducting wire 70 drawn out is wound around the terminal pin 27 (step S13). The conducting wire 70 is wound around the terminal pin 27 upwardly from a position near a lower end of the terminal pin 27 to a position near an upper end of the terminal pin 27. At this time, the conducting wire 70 is wound around the terminal pin 27 with a gap between adjacent turns of the conducting wire 70. After the winding of the conducting wire 70 is completed, the conducting wire 70 is soldered to the terminal pin 27 (step S14). The solder is arranged to intervene between the adjacent turns of the conducting wire 70 wound around the terminal pin 27. Thus, an excellent continuity between the conducting wire 70 and the terminal pin 27 can be achieved. As a result, the electric drive currents supplied from the external power supply can be supplied to the stator 21 with stability, which leads to an improved electrical reliability of the motor 1.

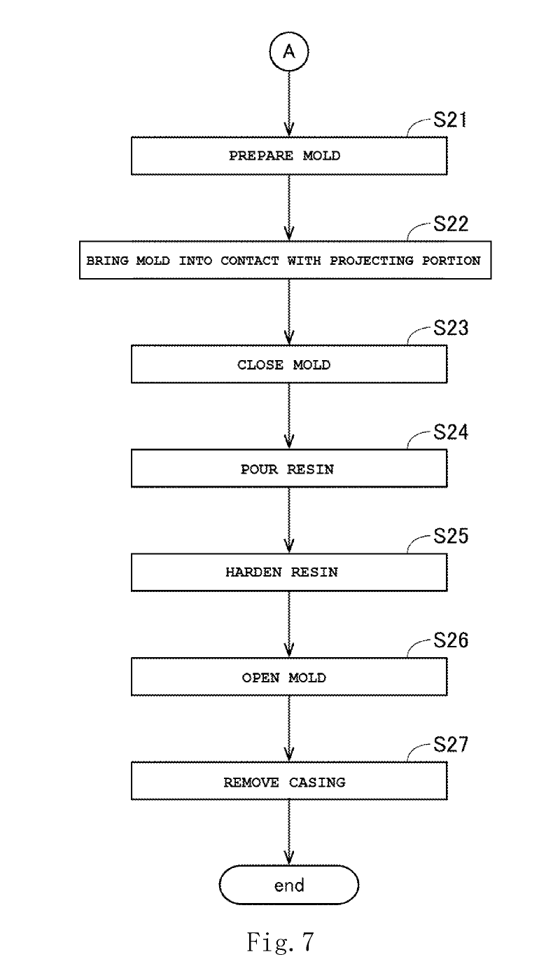

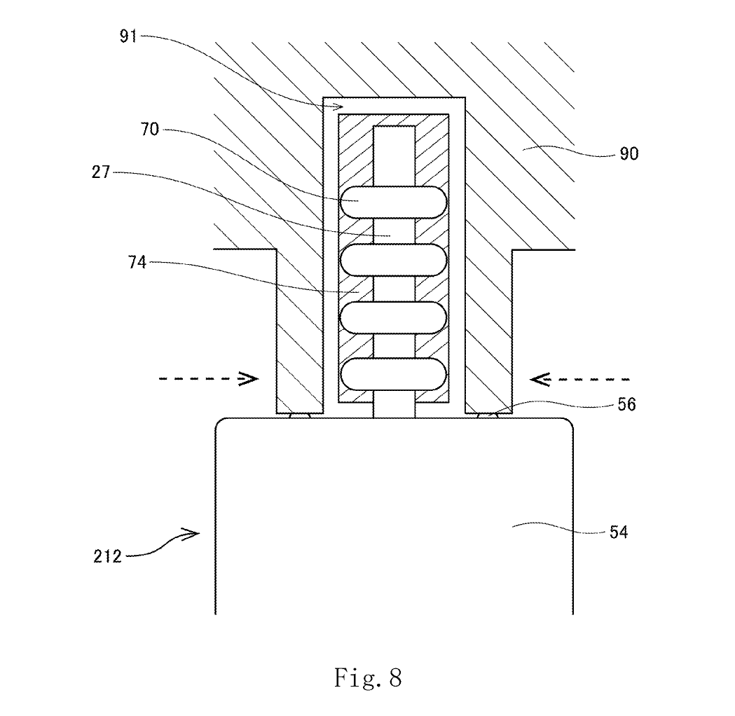

Next, the injection molding of the casing 22 is performed. FIG. 7 is a flowchart illustrating a procedure of the injection molding of the casing 22. FIG. 8 is a diagram illustrating how the injection molding is performed. When the injection molding of the casing 22 is performed, the mold is first prepared (step S21). The mold includes an upper mold 90 and a lower mold (not shown) arranged to together define a cavity therein when fitted to each other. Then, an assembly including the stator 21, the terminal pins 27, and the conducting wires 70, which is obtained by the procedure of FIG. 6, is arranged in the mold.

At this time, as illustrated in FIG. 8, a lower surface of the upper mold 90 is arranged to be in contact with the upper surface of the base portion 54 of the insulator 212. In addition, the terminal pin 27 is surrounded by the upper mold 90.

The lower surface of the upper mold 90 includes a mold recessed portion 91. The mold recessed portion 91 is recessed axially upward above the base portion 54. Once the upper mold 90 is brought into contact with the base portion 54, the terminal pin 27, the third conducting wire portion 73, and the solder 74 are housed in the mold recessed portion 91. Thus, the upper mold 90 and the third conducting wire portion 73 are kept out of contact with each other.

In addition, referring to FIGS. 3 and 8, the insulator 212 according to the present embodiment includes projecting portions 56 each of which is arranged to slightly project upward from the upper surface of the corresponding base portion 54. Each projecting portion 56 is arranged to extend in the shape of a circular arc around the corresponding terminal pin 27. Note, however, that the projecting portion 56 may alternatively be in another shape, such as, for example, a rectangle with a cut portion. It is sufficient if the projecting portion 56 surrounds the terminal pin 27 except for an area over the slit 55. When the upper mold 90 is brought into contact with the upper surface of the base portion 54, the lower surface of the upper mold 90 is brought into contact with the projecting portion 56 (step S22). Then, the projecting portion 56 is crushed by the upper mold 90. Thus, a gap between the upper mold 90 and the base portion 54 is filled in. This contributes to preventing the resin in the fluid state from flowing in toward the terminal pin 27 in a subsequent step.

In addition, referring to FIG. 3, the insulator 212 according to the present embodiment further includes a slit projecting portion 57 arranged adjacent to an upper portion of the slit 55 and continuous with the projecting portion 56. The lower surface of the upper mold 90 is brought into not only the aforementioned projecting portion 56 but also the slit projecting portion 57. The slit projecting portion 57 is crushed by the upper mold 90, and falls toward the slit 55. As a result, an upper opening of the slit 55 is narrowed. This reduces the likelihood that the resin in the fluid state will flow in toward the terminal pin 27 from the slit 55 in the subsequent step.

The projecting portion 56 preferably includes a tapered portion 58 arranged to obliquely extend axially downward with increasing distance from the terminal pin 27. Provision of the tapered portion 58 makes it easier for the projecting portion 56 to fall toward the terminal pin 27 when the projecting portion 56 is crushed. This further reduces the likelihood that the resin in the fluid state will flow in toward the terminal pin 27. In addition, the slit projecting portion 57 preferably includes a tapered portion 59 arranged to obliquely extend axially downward with increasing distance from the slit 55. Provision of the tapered portion 59 makes it easier for the slit projecting portion 57 to fall toward the slit 55 when the slit projecting portion 57 is crushed. This further reduces the likelihood that the resin will flow in toward the terminal pin 27 from the slit 55.

The upper mold 90 and the lower mold are closed (step S23), and thereafter, the resin in the fluid state is poured into the cavity in the mold (step S24). At this time, the resin in the fluid state is supplied to a space outside of the mold recessed portion 91 as indicated by dashed arrows in FIG. 8, but, because the gap between the upper mold 90 and the base portion 54 has been closed as described above, it is not easy for the resin in the fluid state to flow into the mold recessed portion 91. Then, after the resin spreads throughout the cavity in the mold, the resin in the fluid state is hardened (step S25). As a result, the casing 22 is obtained, with the recessed portion 224 defined on the upper side of the base portion 54, and a portion of the terminal pin 27 arranged in the recessed portion 224.

Thereafter, the upper mold 90 and the lower mold are separated from each other to open the mold (step S26). Then, the assembly including the stator 21, the terminal pins 27, the conducting wires 70, and the molded casing 22 is removed from the mold (step S27). In the removed assembly, at least the lower end portion of the terminal pin 27 is arranged in the recessed portion 224. In addition, the second conducting wire portion 72, which is wound around the lower portion of the terminal pin 27, is also arranged in the recessed portion 224. Meanwhile, the third conducting wire portion 73, which is wound around the upper portion of the terminal pin 27, is arranged above the recessed portion 224.

According to the above-described manufacturing procedure, a contact of the conducting wire 70 wound around the terminal pin 27 with the mold can be prevented when the casing 22 is molded. This allows adjacent turns of the conducting wire 70 wound around the terminal pin 27 to have a wide space therebetween. In addition, damage to the conducting wire 70 caused by a contact with the mold can be prevented. Thus, an improvement in the electrical reliability of the motor 1 can be achieved.

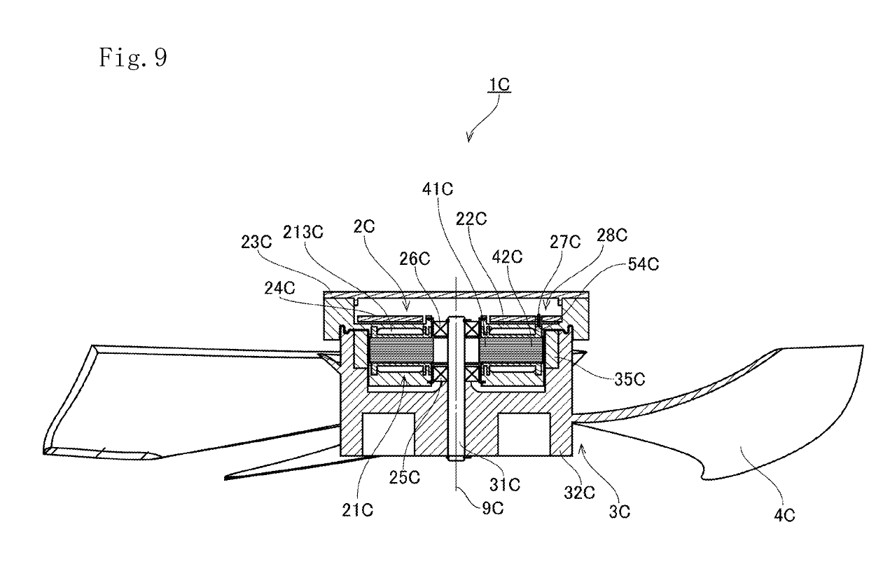

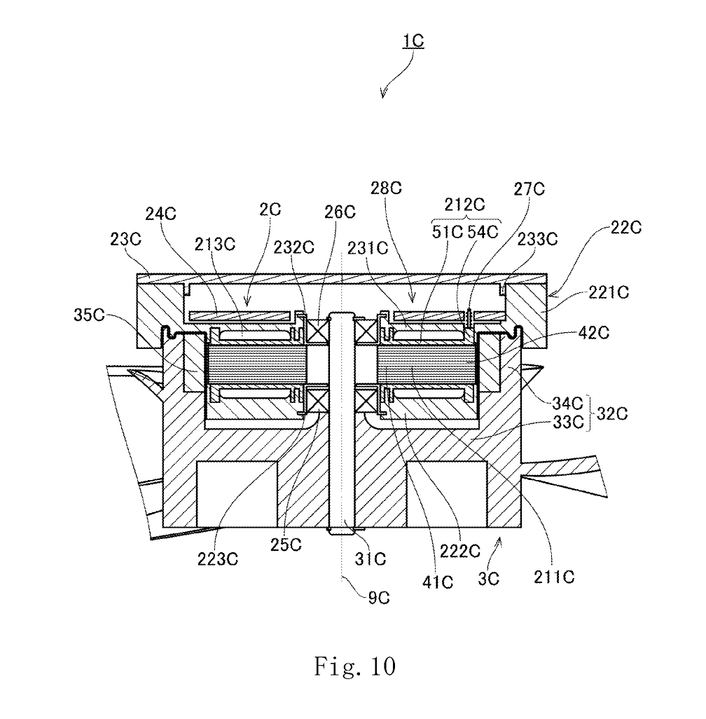

Next, the structure of a motor 1C according to a second embodiment of the present invention will now be described below. A method of injection molding of a casing and the structure of a conductive plate are the same as those of the motor 1 according to the first embodiment, and therefore, descriptions thereof are omitted. FIG. 9 is a vertical sectional view of the motor 1C. FIG. 10 is an enlarged sectional view of the motor 1C. This motor 1C is a so-called outer-rotor motor, in which a magnet 35C is arranged radially outside of a stator 21C. The motor 1C is used in, for example, a household electrical appliance, such as a ceiling fan, an outdoor unit of an air conditioner, or the like. Note that motors according to embodiments of the present invention may be used in applications other than household electrical appliances. For example, motors 1C according to embodiments of the present invention may be installed in transportation equipment, such as an automobile or a railway vehicle, an office automation appliance, a medical appliance, a machine tool, large-scale industrial equipment, and the like, and be used to generate a variety of driving forces.

Referring to FIGS. 9 and 10, the motor 1C includes a stationary portion 2C and a rotating portion 3C. The stationary portion 2C is fixed to a frame of an apparatus which is to be driven. The rotating portion 3C is supported to be rotatable with respect to the stationary portion 2C.

The stationary portion 2C according to the present embodiment includes the stator 21C, a casing 22C, a cover 23C, a conductive plate 24C, a lower bearing portion 25C, an upper bearing portion 26C, and terminal pins 27C. The rotating portion 3C includes a shaft 31C and a rotor 32C.

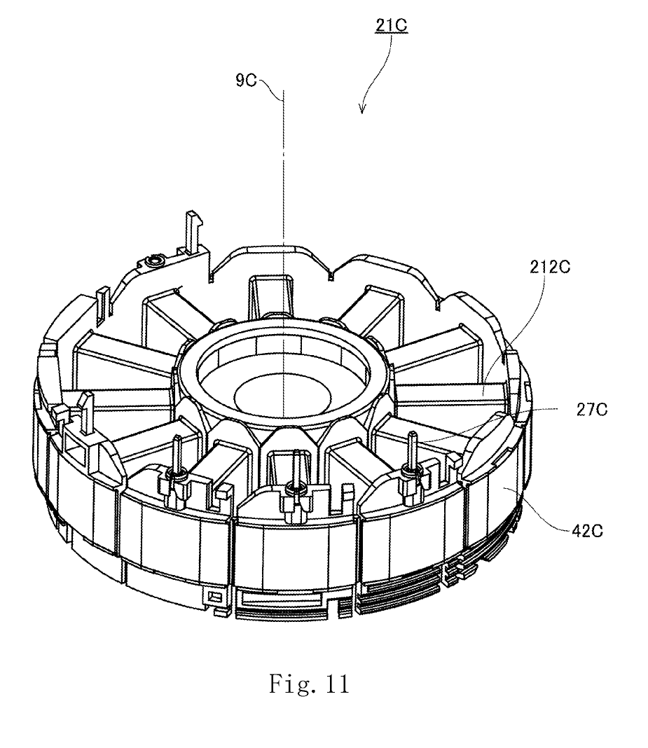

The stator 21C is an armature arranged to generate magnetic flux in accordance with electric drive currents supplied from an external power supply through the conductive plate 24C. FIG. 11 is a perspective view of the stator 21C. In FIG. 11, conducting wires 70C and a solder 74C are not shown. Referring to

FIGS. 9 to 11, the stator 21C is arranged to annularly surround a central axis 9C extending in the vertical direction. The stator 21C includes a stator core 211C, an insulator 212C, and a plurality of coils 213C. The stator core 211C includes a core back 41C in the shape of a circular ring, and a plurality of teeth 42C arranged to project radially outward from the core back 41C. The core back 41C is arranged to be substantially coaxial with the central axis 9C. The teeth 42C are arranged at regular intervals in the circumferential direction. The stator core 211C is defined by, for example, laminated steel sheets.

The insulator 212C is attached to the stator core 211C. An insulating resin is used as a material of the insulator 212C. The insulator 212C is arranged to cover at least both axial end surfaces and both circumferential sides of each of the teeth 42C. Each coil 213C is defined by the conducting wire 70C wound around a corresponding one of the teeth 42C with the insulator 212C intervening therebetween. That is, the insulator 212C is arranged to intervene between the teeth 42C and the coils 213C.

The casing 22C is a member made of a resin, and arranged to hold the stator 21C, the lower bearing portion 25C, and the upper bearing portion 26C. The casing 22C includes a wall portion 221C, a bottom plate portion 222C, an upper plate portion 231C, an upper bearing holding portion 232C, and a lower bearing holding portion 223C. An upper portion of the stator 21C is covered with the resin of the upper plate portion 231C. In addition, the upper plate portion 231C is arranged to extend radially outward up to a position radially outward of the rotor 32C, which will be described below. The wall portion 221C is arranged to extend axially upward from a radially outer end portion of the upper plate portion 231C to substantially assume a cylindrical shape. A lower portion of the stator 21C is covered with the resin of the bottom plate portion 222C.

The lower bearing holding portion 223C is arranged to extend from a radially inner surface of the bottom plate portion 222C toward the shaft 31C to cover a portion of the lower bearing portion 25C. The upper bearing holding portion 232C is arranged to extend from a radially inner surface of the upper plate portion 231C toward the shaft 31C to cover a portion of the upper bearing portion 26C. Each of the lower and upper bearing portions 25C and 26C is thus held. Note that each of the upper and lower bearing holding portions 232C and 223C may either be an integral portion of the casing 22C or be defined by a member separate from the casing 22C.

The cover 23C is arranged to cover an upper opening of the casing 22C. The cover 23C is arranged to extend substantially perpendicularly to the central axis 9C axially above the stator 21C, the casing 22C, the conductive plate 24C, and the rotor 32C. The cover 23C includes a fixing portion 233C arranged to project axially downward to assume the shape of a circular ring. The fixing portion 233C is arranged to be in contact with an inner circumferential portion of the wall portion 221C over the entire circumferential extent thereof. The cover 23C is thus fixed at an upper portion of the casing 22C. In addition, the cover 23C and the casing 22C are arranged to together define an accommodating portion 28C above the stator 21C. That is, at least a portion of the casing 22C is arranged between the accommodating portion 28C and the rotor 32C.

The conductive plate 24C is a circuit board arranged to be substantially perpendicular to the central axis 9C. The conductive plate 24C is arranged in the accommodating portion 28C. The conductive plate 24C is connected to the external power supply through a lead wire, which is not shown. In addition, electric currents supplied from the external power supply are passed to the coils 213C through the lead wire, the conductive plate 24C, and the terminal pins 27C, which will be described below.

The lower bearing portion 25C is arranged to rotatably support the shaft 31C below the stator core 211C. The upper bearing portion 26C is arranged to rotatably support the shaft 31C above the stator core 211C. A ball bearing, which causes an outer race and an inner race to rotate relative to each other through balls, is used as each of the lower and upper bearing portions 25C and 26C according to the present embodiment. The outer race of the lower bearing portion 25C is fixed to the lower bearing holding portion 223C. The outer race of the upper bearing portion 26C is fixed to the upper bearing holding portion 232C. In addition, the inner race of each of the lower and upper bearing portions 25C and 26C is fixed to the shaft 31C. Note, however, that another type of bearing, such as, for example, a plain bearing or a fluid bearing, may be used instead of the ball bearing.

Referring to FIGS. 9 and 10, in the present embodiment, the upper bearing portion 26C is arranged above the core back 41C. In addition, the lower bearing portion 25C is arranged below the core back 41C. Note that at least a portion of each of the upper and lower bearing portions 26C and 25C may be arranged to axially overlap with the core back 41C. In addition, a radially outer tip portion of each of the teeth 42C is arranged radially outward of both the upper and lower bearing portions 26C and 25C. In addition, each terminal pin 27C, which will be described below, is arranged above the radially outer tip portion of the corresponding tooth 42C.

The shaft 31C is a substantially columnar member arranged to extend in the axial direction along the central axis 9C. A metal, such as stainless steel, for example, is used as a material of the shaft 31C. The shaft 31C is arranged to rotate about the central axis 9C.

The rotor 32C is an annular member fixed to the shaft 31C, and arranged to rotate together with the shaft 31C. Referring to FIG. 10, the rotor 32C includes a circular plate portion 33C, a cylindrical portion 34C, and the magnet 35C. The circular plate portion 33C is a plate-shaped portion arranged to extend radially outward from an outer circumferential portion of the shaft 31C. The cylindrical portion 34C is a substantially cylindrical portion arranged radially outward of the circular plate portion 33C. An impeller 4C is attached to an outer circumferential portion of the cylindrical portion 34C.

The magnet 35C is a magnetic body substantially in the shape of a circular ring, and arranged radially outside of the stator 21C. The magnet 35C is fixed to an inner circumferential surface of the cylindrical portion 34C through, for example, an adhesive or the like. Note that the magnet 35C may alternatively be fixed to the inner circumferential surface of the cylindrical portion 34C by another method. An inner circumferential surface of the magnet 35C is arranged opposite to a radially outer end surface of each of the teeth 42C with a slight gap therebetween. In addition, the inner circumferential surface of the magnet 35C includes north and south poles arranged to alternate with each other in the circumferential direction. Note that, in place of the magnet 35C in the shape of a circular ring, a plurality of magnets may be used. In the case where the plurality of magnets are used, the magnets are arranged in the circumferential direction such that north and south poles alternate with each other.

While the motor 1C is running, the electric drive currents are supplied from the external power supply to the coils 213C through the lead wire, which is not shown, the conductive plate 24C, and the terminal pins 27C, which will be described below. As a result, magnetic flux is generated around each of the teeth 42C of the stator core 211C. Then, action of magnetic flux between the teeth 42C and the magnet 35C produces a circumferential torque. As a result, the rotating portion 3C, including the impeller 4C, is caused to rotate about the central axis 9C.

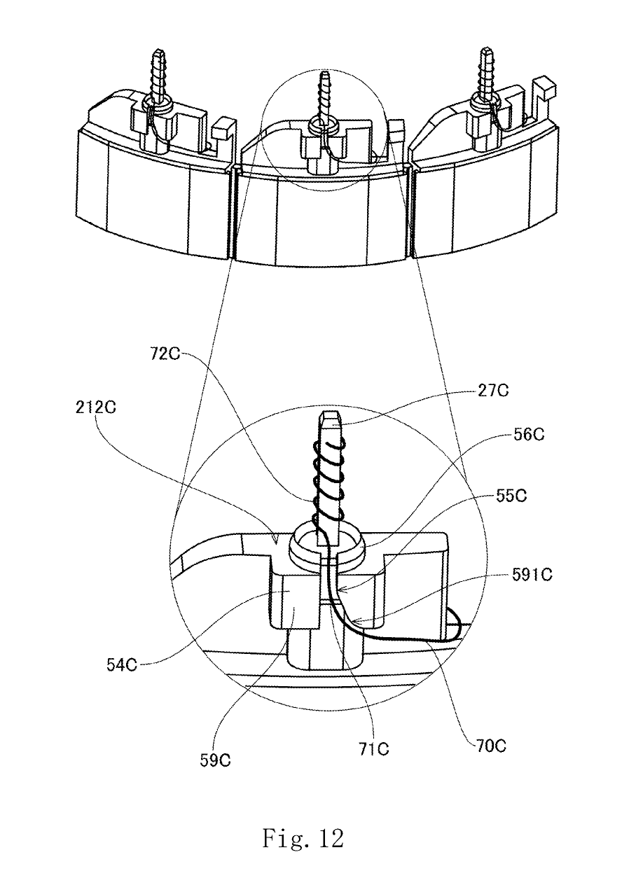

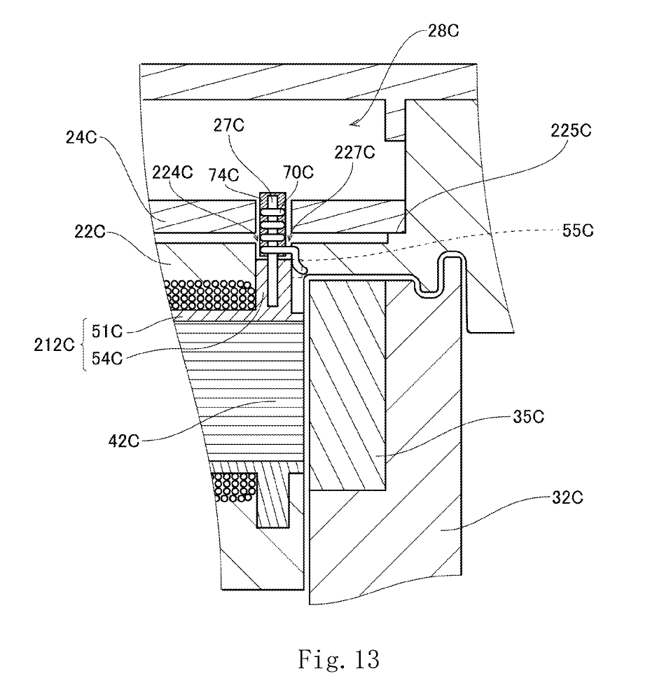

Next, the structure of a vicinity of the terminal pin 27C of the motor 1C will now be described in more detail below. FIG. 12 is a perspective view illustrating the terminal pins 27C and a portion of the insulator 212C. FIG. 13 is a partial sectional view of the motor 1C, illustrating the terminal pin 27C and its vicinity. In FIG. 12, the solder 74C is not shown.

The insulator 212C includes a first insulating portion 51C and a base portion 54C. The first insulating portion 51C and the base portion 54C may be defined either by a single monolithic member or by a plurality of members. The first insulating portion 51C is arranged to cover both the axial end surfaces and both the circumferential sides of a corresponding one of the teeth 42C. A slit 55C recessed radially inward is defined in a radially outer side surface of the base portion 54C. The slit 55C is arranged to extend from an upper end of the base portion 54C downward in the axial direction. In addition, referring to FIG. 12, the insulator 212C according to the present embodiment includes projecting portions 56C each of which is arranged to slightly project upward from an upper surface of the corresponding base portion 54C. The structure of the projecting portion 56C is similar to that of the first embodiment, and therefore, a description thereof is omitted.

The terminal pin 27C is arranged on the base portion 54C. The terminal pin 27C is a columnar conductor arranged to project axially upward toward the accommodating portion 28C. The terminal pin 27C is made of a material having electrical conductivity, such as, for example, iron or copper. A lower end portion of the terminal pin 27C is inserted into a hole defined in the base portion 54C, and is fixed to the base portion 54C. An upper end portion of the terminal pin 27C is arranged above the upper surface of the base portion 54C. In the present embodiment, only one of the terminal pins 27C is fixed to one of the base portions 54C. Note, however, that two or more of the terminal pins 27C may alternatively be fixed to one of the base portions 54C.

In addition, in the present embodiment, the base portion 54C is arranged above a radial tip portion of the corresponding tooth 42C. That is, the terminal pin 27C is arranged above the tip portion of the corresponding tooth 42C. This results in a sufficient insulation distance between the upper bearing portion 26C and the terminal pin 27C. Accordingly, an electrical short circuit between the upper bearing portion 26C and the terminal pin 27C can be prevented. In addition, arranging the terminal pin 27C above the tip portion of the corresponding tooth 42C allows the insulation distance to be sufficient while reducing the radial width of the core back 41C. Thus, a reduction in the size of the motor can be achieved.

At least portions of surfaces of the stator core 211C, the insulator 212C, and the coils 213C are covered with the casing 22C. The casing 22C includes a recessed portion 224C recessed in the axial direction above the base portion 54C of the insulator 212C. The upper surface of the base portion 54C is arranged in the recessed portion 224C. Accordingly, the upper surface of the base portion 54C is exposed from the casing 22C. In addition, at least a lower end portion of the terminal pin 27C is arranged in the recessed portion 224C without contact with the casing 22C.

The casing 22C is obtained by an injection molding process, i.e., pouring the resin into a cavity in a mold with the stator 21C and the terminal pins 27C housed therein and hardening the resin. In addition, referring to FIG. 13, the casing 22C according to the present embodiment includes a conductive plate mounting surface 225C arranged to be in contact with a lower surface of the conductive plate 24C. Thus, a downward displacement of the conductive plate 24C is prevented by the conductive plate mounting surface 225C.

A portion of the conducting wire 70C extends from the coil 213C arranged radially inside of the base portion 54C, and is drawn out toward the slit 55C. The conducting wire 70C includes a first conducting wire portion 71C and a second conducting wire portion 72C. The first conducting wire portion 71C is arranged in the slit 55C. The second conducting wire portion 72C is continuous with the first conducting wire portion 71C, and is wound around a lower portion of the terminal pin 27C. The second conducting wire portion 72C is arranged in the recessed portion 224C. Note that the conducting wire 70C may further include a third conducting wire portion continuous with the second conducting wire portion 72C and wound around an upper portion of the terminal pin 27C. In the above-described manner, the portion of the conducting wire 70C extending from the coil 213C may be arranged to pass through the slit 55C and be wound around the terminal pin 27C from the lower portion to the upper portion of the terminal pin 27C up to a position above the recessed portion 224C. This allows adjacent turns of the conducting wire 70C wound around the terminal pin 27C to have a wide space therebetween, which leads to an improved electrical reliability.

Referring to FIG. 12, in the present embodiment, the base portion 54C of the insulator 212C includes a base projecting portion 59C arranged to project radially outward. In addition, the slit 55C is defined in the base projecting portion 59C from an upper end to a lower end of the base projecting portion 59C. In addition, the base projecting portion 59C includes a curved portion 591C arranged to extend from a side surface thereof which faces the slit 55C to a lower surface thereof while curving in the circumferential direction. Then, the first conducting wire portion 71C is arranged along the curved portion 591C. This allows the conducting wire 70C to be wound around the terminal pin 27C with the conducting wire 70C being caught on the base projecting portion 59C. This makes it easier to lead the conducting wire 70C from a winding portion into the slit 55C. In addition, damage to the conducting wire 70C caused by contact with the base projecting portion 59C can be prevented. Accordingly, a thin wire having a low tensile strength, a conducting wire made of an aluminum alloy, or the like can be used as the conducting wire 70C.

In addition, in the injection molding of the casing 22C of the motor 10 according to the present embodiment, the conducting wire 70C and the mold are kept out of contact with each other without a separate protective member being arranged to cover a portion of the conducting wire 70C which lies between the base portion 54C and the mold. Accordingly, the conducting wire 70C can be wound around the terminal pin 27C up to a position near the upper end portion of the terminal pin 27C without obstruction by such a protective member.

Referring to FIG. 13, in the present embodiment, in the recessed portion 224C, a space 227C is arranged to intervene between the casing 22C and a combination of the second conducting wire portion 72C and the solder 74C. That is, in the injection molding of the casing 22C, the mold is not in contact with any of the terminal pin 27C, the conducting wire 70C, and the solder 74C. Accordingly, damage to each of the terminal pin 27C, the conducting wire 70C, and the solder 74C can be prevented.

In addition, as illustrated in FIG. 13, the conducting wire 70C is wound around the terminal pin 27C with a gap between adjacent turns of the conducting wire 70C. Further, the solder 74C is arranged in the gap between the adjacent turns of the conducting wire 70C wound around the terminal pin 27C. This leads to a more excellent continuity between the conducting wire 70C and the terminal pin 27C. As a result, the electric drive currents supplied from the external power supply can be passed to the stator 21C with stability, which leads to an improved electrical reliability of the motor 10.

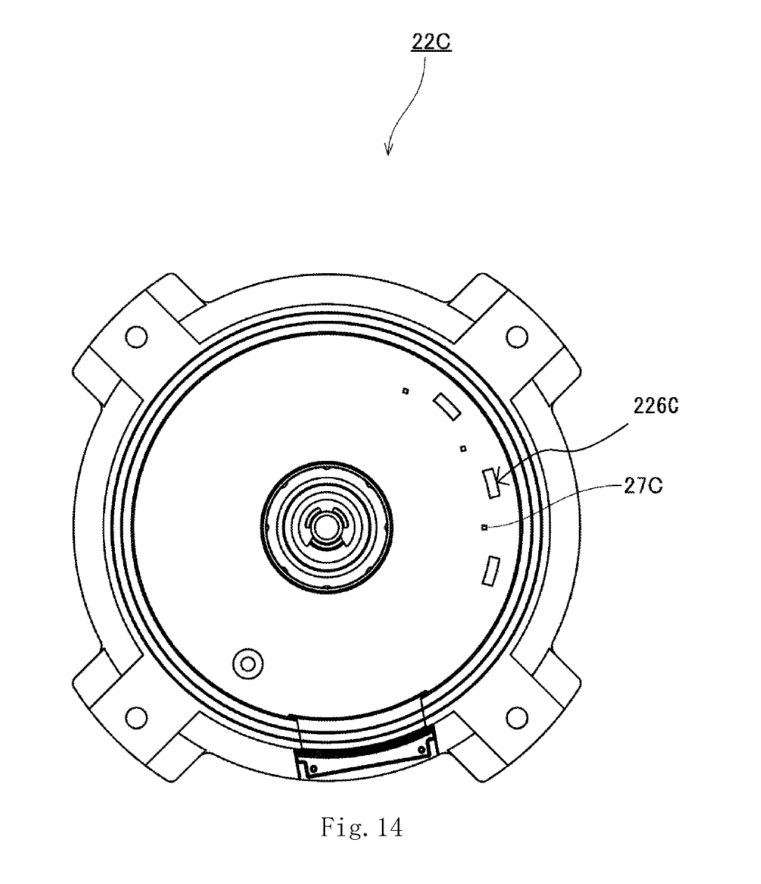

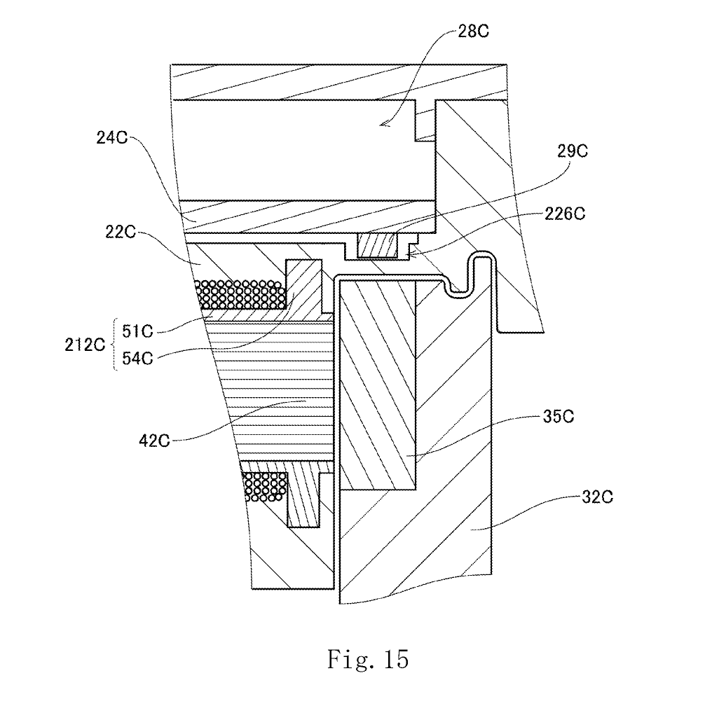

FIG. 14 is a top view of the casing 22C. FIG. 15 is a partial sectional view of the motor 10. In the present embodiment, the casing 22C includes a groove portion 226C recessed downward between adjacent ones of the terminal pins 27C. The groove portion 226C is arranged to axially overlap with at least a portion of the magnet 35C. In addition, a position sensor 29C is arranged in the groove portion 226C. This leads to a concentration of the position sensor 29C and the terminal pins 27C in an area on the casing 22C. This makes it possible to reduce the size of the conductive plate 24C.

The position sensor 29C is, for example, a Hall sensor or the like, and is arranged to detect the magnetic flux of the magnet. The position sensor 29C is arranged in the groove portion 226C, thus axially overlapping with the magnet. Thus, the position sensor 29C is able to detect the position and rotation speed of the rotor 32C. Feedback control of the rotation speed of the rotor 32C is performed on the basis of a result of the detection by the position sensor 29C. Note that the position sensor 29C may be attached to the conductive plate 24C, or may be a member separate from the conductive plate 24C.

While exemplary embodiments of the present invention have been described above, the present invention is not limited to the above-described embodiments.

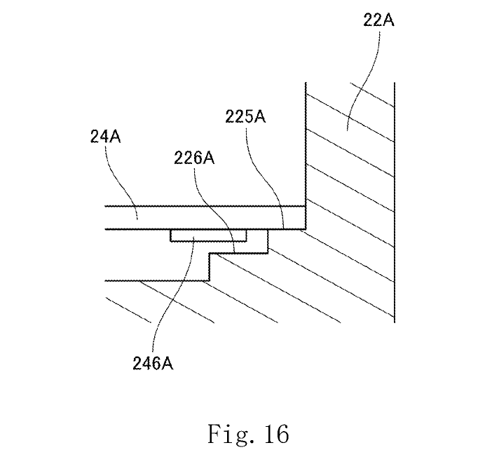

FIG. 16 is a partial vertical sectional view of a motor according to a modified embodiment of the present invention, illustrating an end portion of a conductive plate 24A and its vicinity. In the example of FIG. 16, a casing 22A includes a conductive plate mounting surface 225A and a shoulder surface 226A. The shoulder surface 226A is arranged radially inward of and axially below the conductive plate mounting surface 225A. An axial gap is arranged to intervene between the shoulder surface 226A and a lower surface of the conductive plate 24A. This allows an electronic component 246A to be arranged on the lower surface of the conductive plate 24A at a position above the shoulder surface 226A.

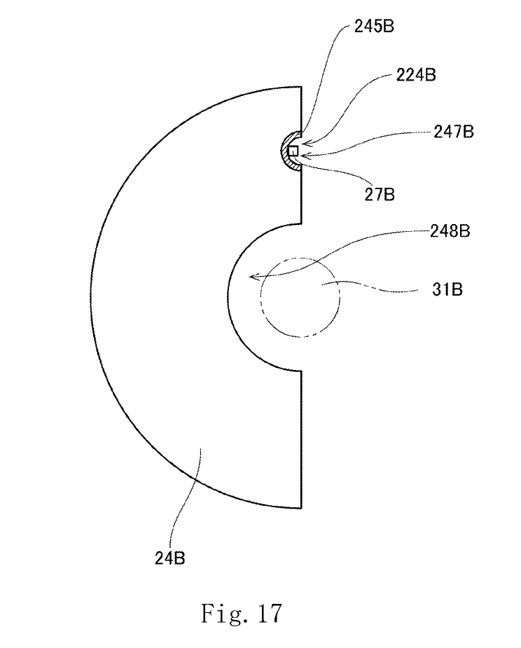

FIG. 17 is a top view of a conductive plate 24B according to another modified embodiment of the present invention. In the example of FIG. 17, the conductive plate 24B includes a first cut 247B arranged above a recessed portion 224B. An inner edge of the first cut 247B includes a land (a second land) 245B, where a copper foil is exposed. A terminal pin 27B is arranged to extend in the axial direction through the first cut 247B. In addition, a conducting wire is wound up to a position above the first cut 247B. That is, an upper end of a third conducting wire portion is arranged above the first cut 247B. The terminal pin 27B is arranged to be in direct contact with the land or in indirect contact with the land with a solder therebetween. Thus, a continuity between the terminal pin 27B and the conductive plate 24B is achieved.

In addition, the conductive plate 24B illustrated in FIG. 17 further includes a second cut 248B arranged to open radially inwardly. At least a portion of a shaft 31B is arranged in the second cut 248B. The first cut 247B and the second cut 248B are arranged to open in the same direction.

The configuration of FIG. 17 allows insertion of the conductive plate 24B to be performed in a lateral direction or in a direction at an angle to the axial direction. Therefore, after a rotating portion having a lower bearing and an upper bearing attached thereto is arranged inside of an injection-molded casing, it is possible to arrange the conductive plate 24B at a position on the side of the upper bearing on which a rotor lies, and solder the terminal pin 27B to the conductive plate 24B. This improves flexibility of operation in a process of manufacturing the motor.

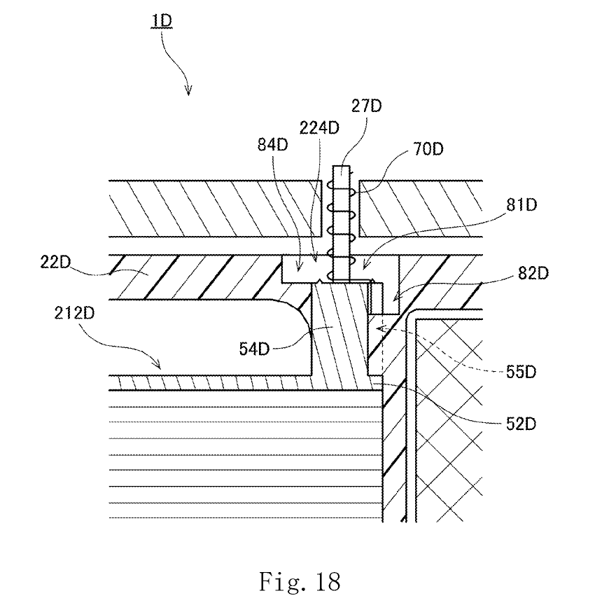

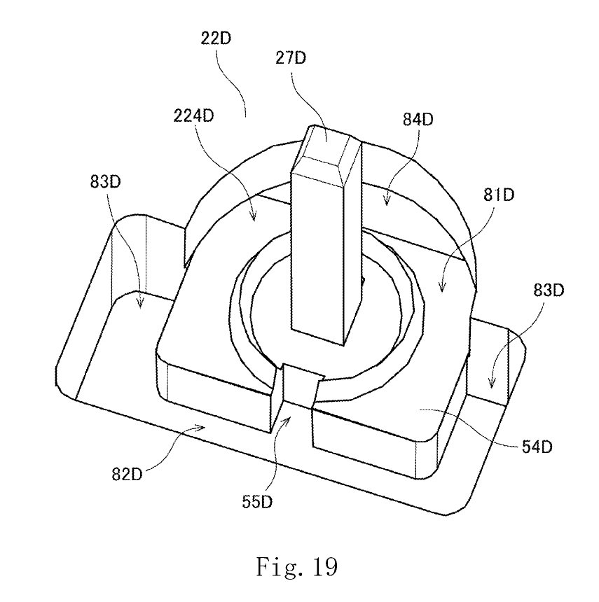

FIG. 18 is a vertical sectional view of a portion of a motor 1D according to another modified embodiment of the present invention, illustrating a terminal pin 27D and its vicinity. FIG. 19 is a partial perspective view of the motor 1D, illustrating a base portion 54D, a casing 22D, and the terminal pin 27D. In the example of FIGS. 18 and 19, a recessed portion 224D of the casing 22D includes a first recessed portion 81D, a second recessed portion 82D, a pair of third recessed portions 83D, and a fourth recessed portion 84D. The first recessed portion 81D, the second recessed portion 82D, the third recessed portions 83D, and the fourth recessed portion 84D are continuous with one another.

The first recessed portion 81D is arranged above the base portion 54D of the insulator 212D. An upper surface of the base portion 54D is exposed in the first recessed portion 81D. At least a portion of the terminal pin 27D is arranged in the first recessed portion 81D. In the example of FIGS. 18 and 19, the upper surface of the base portion 54D is substantially entirely exposed in the first recessed portion 81D. Note that a portion of the upper surface of the base portion 54D may be covered with a resin of the casing 22D.

The second recessed portion 82D is arranged radially outside of the base portion 54D. A side surface of the base portion 54D which includes a slit 55D is exposed in the second recessed portion 82D. In the example of FIGS. 18 and 19, a lower end portion of the second recessed portion 82D is arranged at a level higher than that of an upper surface of a second insulating portion 52D of the insulator 212D. Accordingly, only a portion, including an upper end portion, of the side surface of the base portion 54D which includes the slit 55D is exposed in the second recessed portion 82D. Note that the lower end portion of the second recessed portion 82D may be arranged at a level equal to that of the upper surface of the second insulating portion 52D. Then, the entire side surface of the base portion 54D which includes the slit 55D and a portion of the upper surface of the second insulating portion 52D may be exposed in the second recessed portion 82D.

The pair of third recessed portions 83D are arranged on both circumferential sides of the base portion 54. Both circumferential side surfaces of the base portion 54D are exposed in the third recessed portions 83D. In the example of FIG. 19, a lower end portion of each third recessed portion 83D is arranged at a level higher than that of the upper surface of the second insulating portion 52D of the insulator 212D. Accordingly, only a portion, including an upper end portion, of each circumferential side surface of the base portion 54D is exposed in the corresponding third recessed portion 83D. Note that the lower end portion of the third recessed portion 83D may be arranged at a level equal to that of the upper surface of the second insulating portion 52D. Then, the entire circumferential side surface of the base portion 54D and a portion of the upper surface of the second insulating portion 52D may be exposed in each third recessed portion 83D.

In addition, in the example of FIG. 19, a radially inner end portion of each third recessed portion 83D is arranged radially outward of a radially inner side surface of the base portion 54D. Accordingly, only a radially outer portion of each circumferential side surface of the base portion 54D is exposed in the corresponding third recessed portion 83D. Note that each third recessed portion 83D may alternatively be arranged to extend up to a radial position equal to that of the radially inner side surface of the base portion 54D. However, it is not desirable that a coil 213D be exposed in the third recessed portion 83D.

The fourth recessed portion 84D is arranged radially inside of the terminal pin 27D and above the coil 213D. A lower end portion of the fourth recessed portion 84D is arranged at a level higher than that of an axially lower end portion of each of the second and third recessed portions 82D and 83D. Thus, the fourth recessed portion 84D does not reach the coil 213D. In the example of FIGS. 18 and 19, the lower end portion of the fourth recessed portion 84D is arranged at a level equal to that of the upper surface of the base portion 54D. Note, however, that the lower end portion of the fourth recessed portion 84D may alternatively be arranged at a level different from that of the upper surface of the base portion 54D.

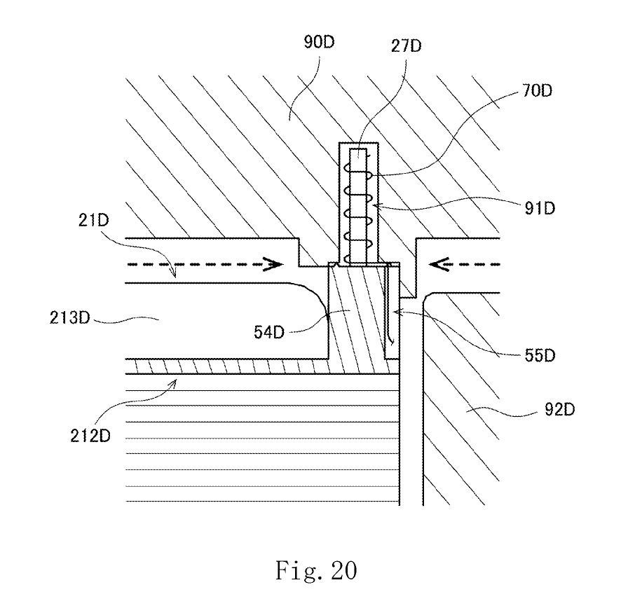

FIG. 20 is a sectional view illustrating how the injection molding of the casing 22D is performed in a process of manufacturing the motor 1D. When the injection molding of the casing 22D is performed, an upper mold 90D and a lower mold 92D which match the shape of the casing 22D are first prepared. Then, an assembly including a stator 21D, the terminal pin 27D, and a conducting wire 70D is arranged between the upper mold 90D and the lower mold 92D.

At this time, as illustrated in FIG. 20, a lower surface of the upper mold 90D is arranged to be in contact with the upper surface of the base portion 54D. In addition, the terminal pin 27D is surrounded by the upper mold 90D. Specifically, the terminal pin 27D is housed in a mold recessed portion 91D defined in the upper mold 90D. Thus, the upper mold 90D and the conducting wire 70D are kept out of contact with each other. In addition, in the example of FIG. 20, the upper mold 90D is arranged to be in contact with the side surface of the base portion 54D which includes the slit 55D and both circumferential side surfaces of the base portion 54D as well. This causes a space inside of the mold recessed portion 91D to be more securely isolated from a surrounding space.

Thereafter, the resin in a fluid state is poured into a cavity defined between the upper mold 90D and the lower mold 92D as indicated by dashed arrows in FIG. 20. At this time, it is not easy for the resin to flow into the space inside of the mold recessed portion 91D. In particular, in the example of FIG. 20, the upper mold 90D is arranged to be in contact with not only the upper surface of the base portion 54D but also the side surface of the base portion 54D which includes the slit 55D. This reduces the likelihood that the resin will flow into the space inside of the mold recessed portion 91D through a vicinity of the slit 55D. In addition, in this example, the upper mold 90D is arranged to be in contact with the circumferential side surfaces of the base portion 54D as well. This further reduces the likelihood that the resin will flow into the space inside of the mold recessed portion 91D. As a result, an additional reduction in the likelihood that the resin will intrude into a region surrounding the terminal pin 27D can be achieved.

In addition, in the example of FIG. 20, a portion of the upper mold 90D is arranged at a position radially inside of the terminal pin 27D and above the coil 213D, i.e., at a position at which the fourth recessed portion 84D is to be defined after the molding. This reduces the likelihood that the resin will intrude into the region surrounding the terminal pin 27D through a vicinity of the coil 213D.

Then, after the resin spreads throughout the cavity between the upper mold 90D and the lower mold 92D, the resin in the fluid state is hardened. As a result, the casing 22D, including the first, second, third, and fourth recessed portions 81D, 82D, 83D, and 84D, is obtained.

In the above-described first embodiment, the shaft is arranged to project above the casing and the cover. Note, however, that the shaft may alternatively be arranged to project downward below the casing, with the lower end portion of the shaft being connected to a driving portion. Also note that the shaft may alternatively be arranged to project both below the casing and above the cover, with both the lower end portion and the upper end portion of the shaft being connected to a driving portion.

In the above-described first embodiment, the rotor made of a magnetic resin is used. Note, however, that a rotor including a cylindrical rotor core made of a magnetic material and a plurality of magnets fixed to an outer circumferential surface of the rotor core or fixed in the rotor core may alternatively be used.

The conductive plate according to the above-described embodiment is a circuit board on which an electronic circuit to supply the electric drive currents to the coils is mounted. Note, however, that the conductive plate may alternatively be a wiring stand arranged to support a lead wire. In this case, the lead wire may be arranged along a surface of the wiring stand, and be directly connected to the terminal pin.

In the above-described embodiment, the terminal pin and the conducting wire are electrically connected to each other through soldering. Note, however, that the terminal pin and the conducting wire may alternatively be electrically connected to each other by another method, such as, for example, thermal crimping, use of an electrically conductive adhesive, or welding.

In the above-described embodiment, a section of the terminal pin, which is made of a metal, perpendicular to the central axis is rectangular. Note, however, that the section of the terminal pin may alternatively be in another shape, such as, for example, a circle.

Note that the detailed shape of any member may be different from the shape thereof as illustrated in the accompanying drawings of the present application. Also note that features of the above-described embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A motor comprising:
a stationary portion including a stator; and
a rotating portion including a rotor arranged to rotate about a central axis extending in a vertical direction, and arranged radially opposite to the stationary portion; wherein
the stationary portion includes:
a stator core including an annular core back and a plurality of teeth arranged to project radially from the core back;
an insulator arranged to cover at least a portion of the stator core, and including a base portion including a slit defined therein;
coils each of which is defined by a conducting wire wound around a separate one of the teeth with the insulator therebetween;
a terminal pin arranged to extend upward from the base portion of the insulator;
a conductive plate arranged above the stator; and
a casing made of a resin, and arranged to cover the stator core, the insulator, and the coils;
the casing includes a recessed portion recessed in an axial direction;
at least a portion of the terminal pin is arranged in the recessed portion; and
the conducting wire includes:
a first conducting wire portion arranged in the slit defined in the base portion; and
a second conducting wire portion continuous with the first conducting wire portion, and wound around a lower portion of the terminal pin.

2. The motor according to claim 1, wherein
the conducting wire is wound around the terminal pin with a gap between adjacent turns of the conducting wire; and
a solder is arranged in the gap.

3. The motor according to claim 2, wherein, in the recessed portion, a space is arranged to intervene between the casing and a combination of the second conducting wire portion and the solder.

4. The motor according to claim 3, wherein
the conducting wire further includes a third conducting wire portion continuous with the second conducting wire portion, and wound around an upper portion of the terminal pin; and
the third conducting wire portion is arranged above the recessed portion.

5. The motor according to claim 4, wherein
the recessed portion includes a first recessed portion; and
an upper surface of the base portion is exposed in the first recessed portion.

6. The motor according to claim 5, wherein
the recessed portion further includes a second recessed portion; and
a side surface of the base portion which includes the slit is exposed in the second recessed portion.

7. The motor according to claim 6, wherein
the recessed portion further includes a third recessed portion; and
the base portion includes a circumferential side surface exposed in the third recessed portion.

8. The motor according to claim 6, wherein
the recessed portion further includes a fourth recessed portion;
the fourth recessed portion is arranged above a corresponding one of the coils; and
a lower end portion of the fourth recessed portion is arranged at a level higher than that of a lower end portion of the second recessed portion.

9. The motor according to claim 1, wherein an upper surface of the base portion includes a projecting portion arranged around the terminal pin.

10. The motor according to claim 1, wherein
the base portion further includes a base projecting portion arranged to project radially outward; and
the slit is defined in the base projecting portion from an upper end to a lower end of the base projecting portion.

11. The motor according to claim 10, wherein
the base projecting portion includes a curved portion arranged to extend from a side surface thereof which faces the slit to a lower surface thereof while curving in a circumferential direction; and
the first conducting wire portion is arranged along the curved portion.

12. The motor according to claim 1, wherein the conducting wire is made of an aluminum alloy.

13. The motor according to claim 1, wherein
the casing includes a conductive plate mounting surface arranged to be in contact with a lower surface of the conductive plate; and
the conductive plate mounting surface is arranged at a level higher than that of an upper end portion of at least an outer circumferential portion of the rotor.

14. The motor according to claim 13, wherein
the casing includes a shoulder surface arranged axially below the conductive plate mounting surface on a radially inner side of the conductive plate mounting surface; and
an axial gap is arranged to intervene between the shoulder surface and the lower surface of the conductive plate.

15. The motor according to claim 4, wherein
the conductive plate includes a through hole arranged above the recessed portion, with a wall portion of the through hole including a first land;
the terminal pin is arranged in the through hole, and is arranged to be in direct contact with the first land or in indirect contact with the first land with a solder therebetween; and
an upper end of the third conducting wire portion is arranged above the through hole.

16. The motor according to claim 4, wherein
the conductive plate includes a first cut arranged above the recessed portion, with an inner edge of the first cut including a second land;
the terminal pin is arranged in the first cut, and is arranged to be in direct contact with the second land or in indirect contact with the second land with a solder therebetween; and
an upper end of the third conducting wire portion is arranged above the first cut.

17. The motor according to claim 16, wherein
the rotating portion further includes a shaft arranged to extend in the axial direction through the rotor;
the conductive plate includes a second cut arranged to open radially inwardly;
at least a portion of the shaft is arranged in the second cut; and
the first cut and the second cut are arranged to open in a same direction.

18. The motor according to claim 1, wherein a shape of the terminal pin in a section perpendicular to the central axis is rectangular.

19-28. (canceled)
